(19) United States
(12) Patent Application Publication
(10) Pub. No.: US 2014/0042771 A1
(43) Pub. Date: Feb. 13, 2014

(54) Waterproof Car Cover

(71) Applicant: Wen Liang Lo, Tainan City (TW)

(72) Inventor: Wen Liang Lo, Tainan City (TW)

(21) Appl. No.: 13/572,746

(22) Filed: Aug. 13, 2012

(51) Int. Cl. B60J 11/04

(52) U.S. Cl. 296/136.07

(57) ABSTRACT

A waterproof car cover includes a waterproof floor mat, a hollow interconnected side bar around the periphery of the floor mat, a waterproof inflation hole at an end of the sidebar, a waterproof cover body on a side of the floor mat, and a corresponding waterproof zipper on the cover body and the floor mat. Thus, after a car is parked on the floor mat, air enters from an inflation hole into the sidebar to expand the sidebar. The cover body covers the car, and a zipper of the cover body and the floor mat is zipped up to cover the car inside the waterproof cover, to isolate the car from the outside and to prevent the car from soaking water and to prevent a car body of the car from being scratched by drifting sand and stone, and to achieve the effect of floating and balancing the car body.

### BACKGROUND OF THE INVENTION

1. Field of the Invention

The present invention relates to a waterproof car cover, and more particularly to the waterproof car cover capable of preventing a car from being sunk by a flood or a car body from being scratched by drifting sand and stone, and achieving the effects of flowing and balancing the car body.

2. Description of the Related Art

The global meteorological change caused by global warming is an indisputable fact, and the impact of the rainy season or heavy rains brought by typhoons during the typhoon season is a lingering fear of many people, and cars parked in low-lying areas may be attached by floods and damaged by soaking water, and a car body is scratched by drifting sand and stone, which causes tremendous monetary losses.

### SUMMARY OF THE INVENTION

In view of the aforementioned drawbacks of the prior art, the inventor of the present invention based on years of experience in the related industry to conduct extensive researches and experiments, and finally invented the present invention to overcome the drawbacks of the prior art.

Therefore, it is a primary objective of the present invention to provide a waterproof car cover capable of preventing a car from being sunk by a flood or a car body from being scratched by drifting sand and stone, and achieving the effects of flowing and balancing the car body.

To achieve the aforementioned objective, the present invention provides a waterproof car cover, comprising a waterproof floor mat, a hollow interconnected sidebar disposed around the periphery of the floor mat, a waterproof inflation hole formed at an end of the sidebar, a waterproof cover body disposed on a side of the floor mat, and a corresponding waterproof zipper installed at the cover body and the floor mat, so that after the car is parked on the floor mat, the inflation hole is provided for introducing air into the sidebar to expand the sidebar, and the cover body is provided for covering the car, and the cover body and the zipper of the floor mat are zipped up to cover the car inside the waterproof cover and isolate the car from the outside, so as to prevent the car from soaking water or the car body from being scratched by drifting sand and stone and achieve the effects of floating and balancing the car body.

In the waterproof car cover, a retaining ring is installed at at least one corner of the floor mat.

In the waterproof car cover, the retaining ring is coupled to a rope.

In the waterproof car cover, a tire positioning grid is disposed separately at four corners of the top of the floor mat.

In the waterproof car cover, the waterproof car cover is made of a wear-resisting anti-scratch material.

### BRIEF DESCRIPTION OF THE DRAWINGS

FIG. 1 is a perspective view of a preferred embodiment of the present invention;

FIG. 2 is a perspective view of an application in accordance with a preferred embodiment of the present invention;

FIG. 3 is a side view of an application in accordance with a preferred embodiment of the present invention;

FIG. 4 is a first schematic view of an application in accordance with a preferred embodiment of the present invention;

FIG. 5 is a second schematic view of an application in accordance with a preferred embodiment of the present invention;

FIG. 6 is a third schematic view of an application in accordance with a preferred embodiment of the present invention;

FIG. 7 is a fourth schematic view of an application in accordance with a preferred embodiment of the present invention; and

FIG. 8 is a fifth schematic view of an application in accordance with a preferred embodiment of the present invention.

### DETAILED DESCRIPTION OF THE PREFERRED EMBODIMENTS

The objectives, technical characteristics, measures, effects and advantages of the present invention will become apparent with the detailed description of preferred embodiment accompanied with the illustration of related drawings as follows.

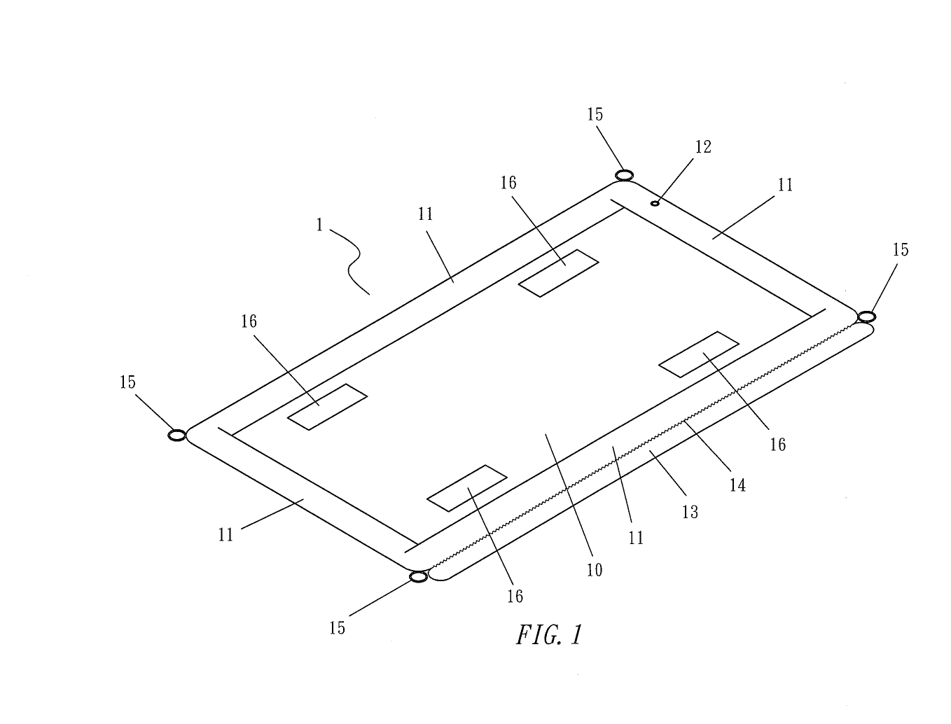

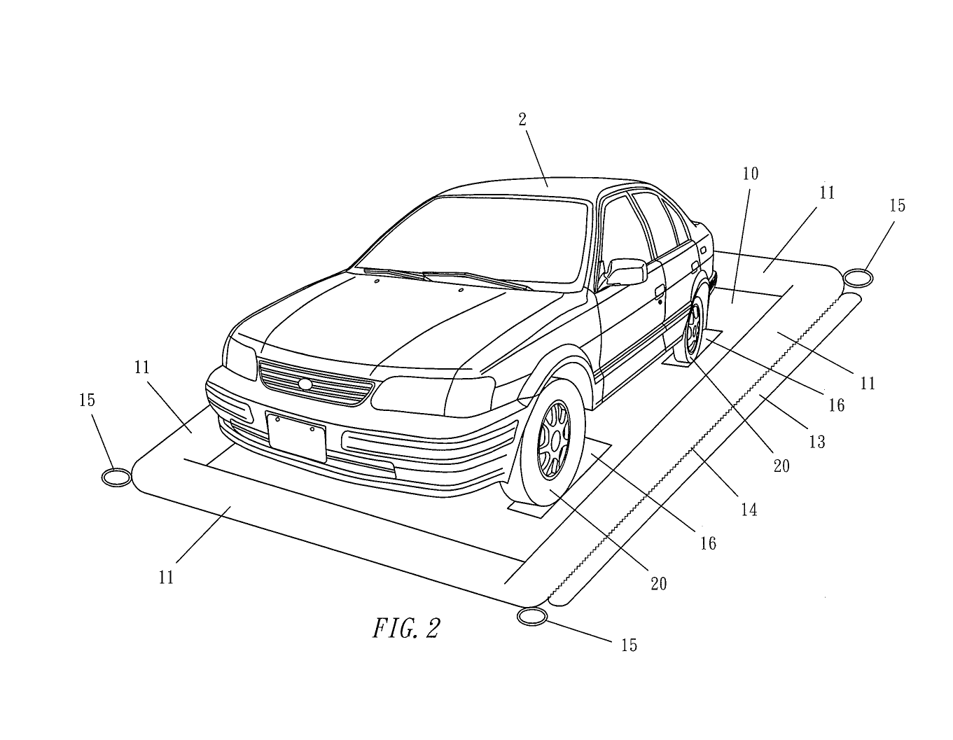

With reference to FIGS. 1 to 3, a waterproof car cover 1 of the invention is made of a wear-resisting anti-scratch material and comprises a waterproof floor mat 10, a hollow interconnected sidebar 11 disposed around the periphery of the floor mat 10, a waterproof inflation hole 12 formed at an end of the sidebar 11, a waterproof cover body 13 disposed on a side of the floor mat 10 and a corresponding waterproof zipper 14 installed to the cover body 13 and the floor mat 10, a retaining ring 15 installed separately at four corners of the floor mat 10, and a tire positioning grid 16 disposed separately at four corners of the floor mat 10.

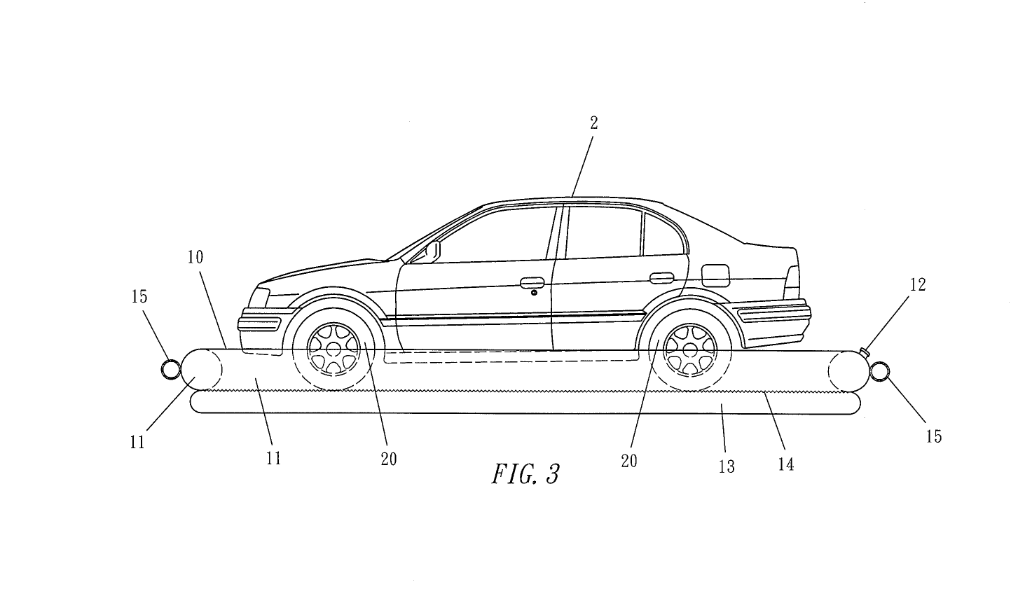

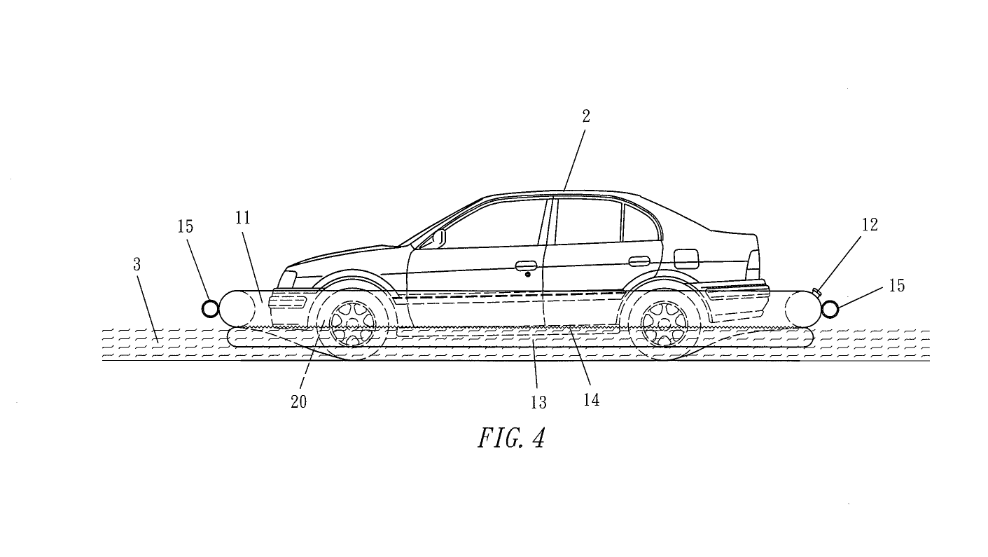

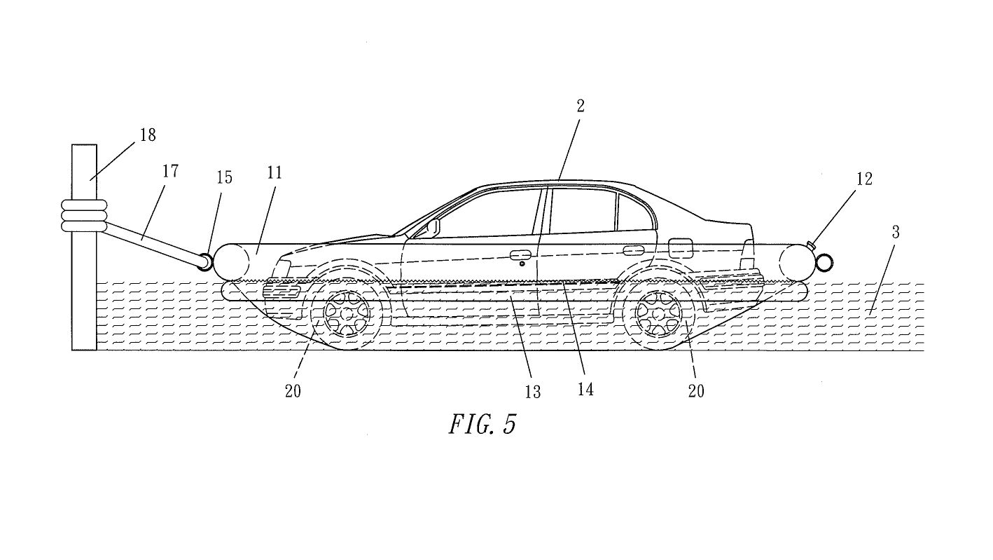

With reference to FIGS. 3 to 5, a car 2 is parked on top of the floor mat 10 of the waterproof car cover 1 during use, so that four tires 20 of the car 2 are disposed on the tire positioning grids 16 respectively, and the inflation hole 12 of the waterproof car cover 1 is opened to start an inflation (wherein exhaust gas of the car 2 or any other inflation device can be used for the inflation). After the sidebar 11 of the floor mat 10 is inflated appropriately, the sidebar 11 is expanded. And then, a rope 17 is passed through the retaining ring 15 and tied to a fixed object 18 such as a utility pole, a fence or a tree trunk to prevent the floor mat 10 from drifting together with a flood 3.

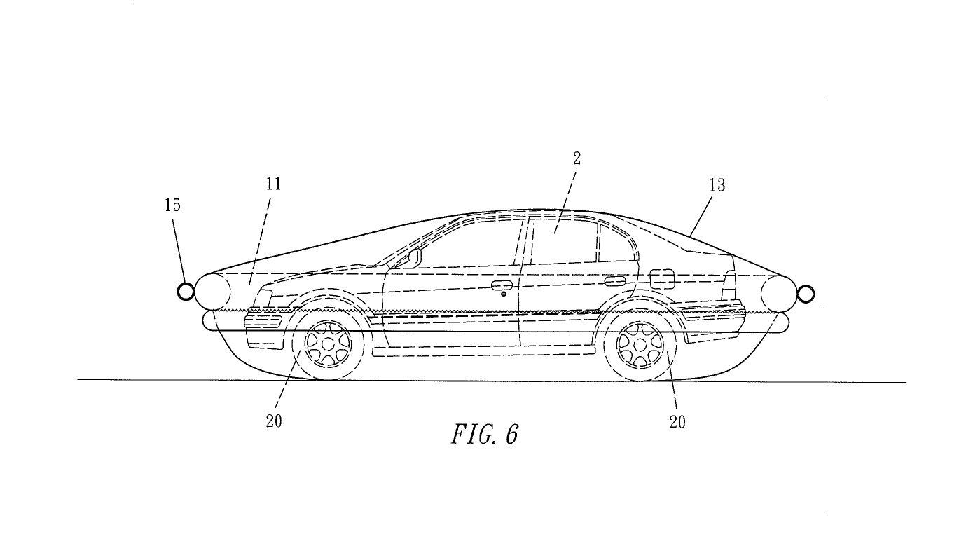

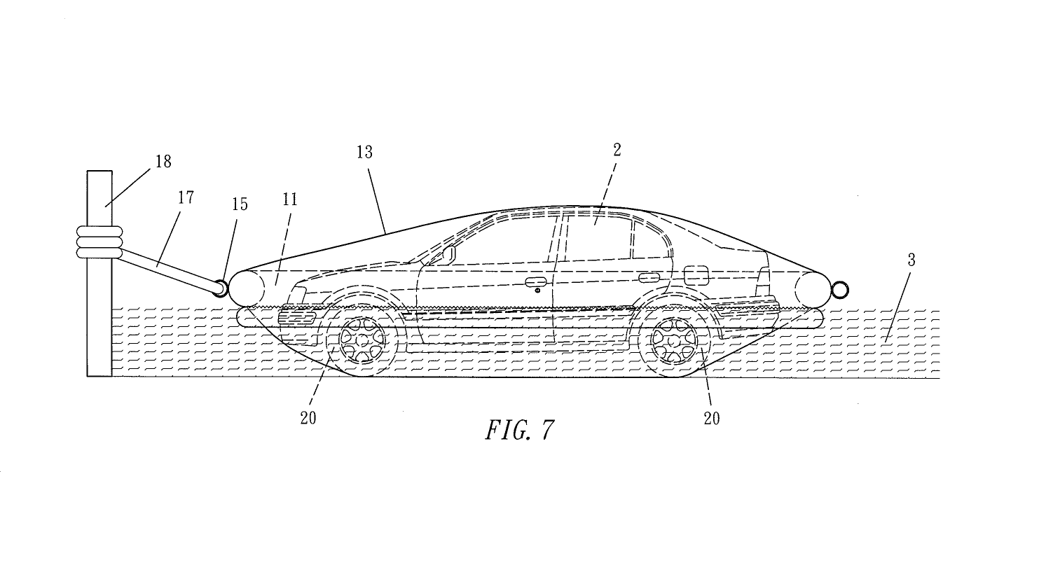

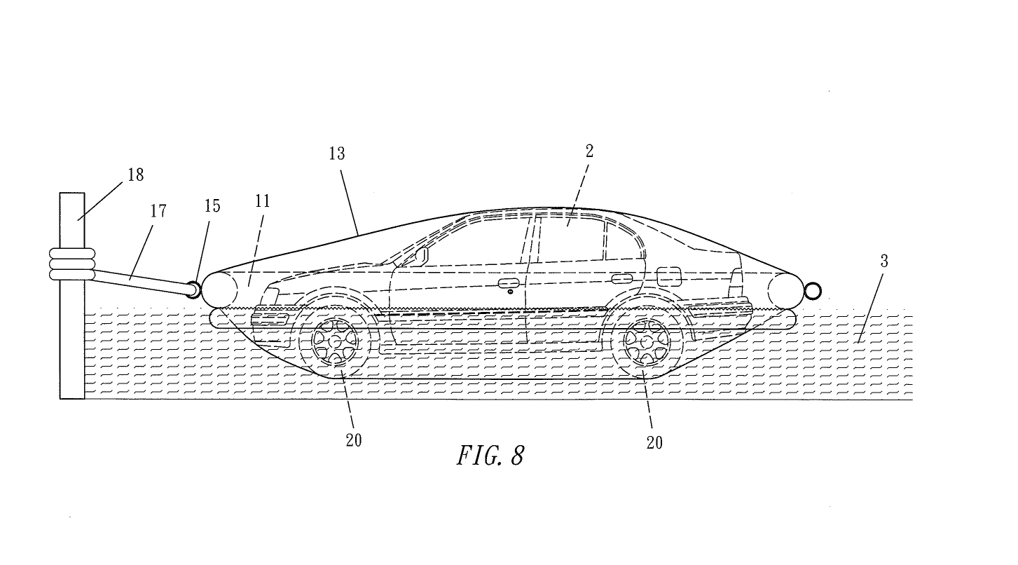

With reference to FIGS. 6 to 8, if a user worries about a too-large flood 3, the user can cover the whole car 2 by the cover body 13 of the waterproof car cover 1 and then zip up the zipper 14 of the cover body 13 and the floor mat 10 after the car 2 is parked on top of the floor mat 10 and the inflation is completed, so as to achieve the effects of covering the car 2 completely, isolating the car 2 from the outside, preventing the car from being sunk by the flood 3, and floating and balancing the car body.

When the car 2 is parked on the top of the floor mat 10, four tires 20 of the car are disposed on the tire positioning grids 16 respectively, and the inflation hole 12 is opened to start the inflation. After air is inflated appropriately, the sidebar 11 is expanded, and then a rope 17 is passed through the retaining ring 15, and the rope 17 is tied to the fixed object 18 to prevent the floor mat 10 to drift together with the flood 3. If the user worries about a too-large flood 3, the user can cover the whole car 2 by the cover body 13 and zip up the zipper 14 to cover the whole car 2, after the car 2 is parked on top of the floor mat 10 and the inflation is completed, so as to achieve the effects of isolating the car 2 from the outside, preventing the car from being sunk by the flood 3, preventing the car body from being scratched by drifting sand and stone, and floating and balancing the car body.

In summation of the description above, the present invention achieves the expected objectives and effects and complies with the patent application requirements, and thus is duly filed for patent application. While the invention has been described by means of specific embodiments, numerous modifications and variations could be made thereto by those skilled in the art without departing from the scope and spirit of the invention set forth in the claims.

1. A waterproof car cover comprising:
a waterproof floor mat formed of material sufficient to park and support a car thereon, with the waterproof floor mat having a periphery;
means disposed around the periphery of the floor mat for floating the waterproof floor mat and the car parked thereon, with the floating means comprising a hollow, inflatable, interconnected, side bar disposed around the periphery of the floor mat and of an annular shape, with the waterproof floor mat located inside the annular shape;
a waterproof inflation hole formed at an end of the sidebar;
a waterproof cover body disposed on a side of the floor mat; and
a corresponding waterproof zipper installed on the cover body and the floor mat, wherein after the cover body covers a car, the waterproof zipper zips up the waterproof cover body and the waterproof floor mat.

2. The waterproof car cover of claim 1, wherein the waterproof floor mat has a retaining ring installed at least at one corner of the waterproof floor.

3. The waterproof car cover of claim 2, wherein the retaining ring is coupled to a rope.

4. The waterproof car cover of claim 1, wherein the waterproof floor mat has a tire positioning grid disposed separately at four corners of the waterproof floor mat.

5. The waterproof car cover of claim 1, wherein the waterproof car cover is made of a wear-resisting, anti-scratch material.
